(19) United States
(12) Patent Application Publication
(10) Pub. No.: US 2012/0128154 A1
(43) Pub. Date: May 24, 2012

(54) ESTABLISHING A SECURE PROXIMITY PAIRING BETWEEN ELECTRONIC DEVICES

(75) Inventor: Alexander S. Ran, Palo Alto, CA (US)

(73) Assignee: INTUIT INC., Mountain View, CA (US)

(21) Appl. No.: 12/952,817

(22) Filed: Nov. 23, 2010

(51) Int. Cl. H04K 1/00

(52) U.S. Cl. 380/255

(57) ABSTRACT

A technique for establishing a common encrypted link between a first electronic device and a second electronic device in physical proximity in a system is described. During operation of the system, a user of a first electronic device in the system provides a notification that initiates secure device pairing. In response to the notification, the first electronic device conducts a first key exchange in an audible audio spectrum to the second electronic device in the system using a first zero-knowledge protocol. After the first key is received by the second electronic device, the second electronic device conducts a second key exchange in the audible audio spectrum to the first electronic device using a second zero-knowledge protocol, thereby establishing the common encrypted link between the first electronic device and the second electronic device.

### BACKGROUND

The present disclosure relates to a technique for establishing a secure link between electronic devices in physical proximity. More specifically, the present disclosure relates to a technique for establishing a common encrypted link between two electronic devices by exchanging keys in the audible audio spectrum using one or more zero-knowledge protocols.

Many financial and legal transactions are conducted via face-to-face interactions (such as obtaining a reservation or a quote, paying a bill, signing an agreement or a contract, etc.). In principle, these interactions may be facilitated using portable electronic devices, such as cellular telephones. For example, cellular telephones can be used to digitally capture interaction content (such as the details of a contract that has been signed), and to seamlessly integrate it into backend processing systems, such as: legal or financial management systems, payment networks, banking systems, etc.

However, many financial and legal transactions are sensitive in nature. As such, it is often necessary for these transactions to be conducted securely. In order to conduct a financial or a legal transaction securely through portable electronic devices, a ‘secure session’ typically needs to be established between the portable electronic devices. In particular, a ‘secure session’ often involves a secure pairing of the portable electronic devices and establishing a confidential communication channel between the paired portable electronic devices. For example, a confidential communication channel can be created using the Diffie-Hellman (D-H) key exchange protocol. This protocol allows two entities, with no prior shared secrets or trusted associations, to agree on a common secret key, thereby establishing a secure communication channel.

However, communication between portable electronic devices is typically wireless, and usually occurs in one or more frequency bands that the participants cannot perceive. As a consequence, such communication is vulnerable to a so-called ‘man-in-the-middle’ (MITM) attack, in which a third party intercepts communication between two portable electronic devices. Furthermore, a MITM attack can occur while the confidential communication channel is being established. Therefore, users cannot be sure that they are communicating solely with the party they intend to interact with via the confidential communication channel, i.e., whether the confidential communication channel is secure. This uncertainty can impede the use of portable electronic devices in financial and legal transactions, which, in turn, can pose an obstacle to commercial activity.

### SUMMARY

The disclosed embodiments relate to a system that establishes a common encrypted link between a first electronic device and a second electronic device. During operation, the first electronic device receives a notification that a user has initiated secure device pairing. In response to the notification, the first electronic device conducts, in an audible audio spectrum, a first key exchange with the second electronic device in the system using a first zero-knowledge protocol. After the first key is received by the second electronic device, the second electronic device conducts, in the audible audio spectrum, a second key exchange with the first electronic device using a second zero-knowledge protocol, thereby establishing the common encrypted link between the first electronic device and the second electronic device. Moreover, by exchanging the keys using the audible audio spectrum, a user of either of the electronic devices can determine or monitor that there is no third party interference when the common encrypted link is established, for example, the user can confirm that a third party did not listen to the key exchange.

Note that the first zero-knowledge protocol and the second zero-knowledge protocol may be the same. Alternatively, the first zero-knowledge protocol may be different than the second zero-knowledge protocol. Moreover, the common encrypted link may use the first key and the second key. In addition, private keys may be used to encode and/or decode communication via the common encrypted link.

In some embodiments, the first electronic device and/or the second electronic device generate a shared key based on the first key and the second key, where the common encrypted link uses the shared key. Moreover, the shared key may also be generated by the first electronic device and/or the second electronic device using additional private keys on the first electronic device and/or the second electronic device.

Furthermore, the first electronic device and the second electronic device may be physically proximate to each other. For example, a distance between the first electronic device and the second electronic device may be less than a predefined distance (such as one inch, one foot or one meter).

In some embodiments, additional information is exchanged between the first electronic device and the second electronic device via the common encrypted link to establish another communication channel between the first electronic device and the second electronic device.

Additionally, the first key exchange and the second key exchange may be performed multiple times until the common encrypted link is successfully established.

In some embodiments, the first electronic device receives user approval of the common encryption link. If user approval of the common encrypted link is not received, the first electronic device and/or the second electronic device may disable the common encrypted link between the first electronic device and the second electronic device.

Note that, during the first key exchange, the first key may be encoded in a first audio signal, and during the second key exchange the second key is encoded in a second audio signal. The first audio signal may be the same as or different than the second audio signal.

Another embodiment provides an electronic device, which may be used in the system. This electronic device is configured to receive a notification that a user has initiated secure device pairing. Furthermore, in response to the notification, the electronic device is configured to conduct, in an audible audio spectrum, a first key exchange from the electronic device to a second electronic device using a first zero-knowledge protocol. Then, the electronic device is configured to conduct, in the audible audio spectrum, a second key exchange from the second electronic device to the electronic device using a second zero-knowledge protocol, thereby establishing the common encrypted link between the electronic device and the second electronic device.

Another embodiment provides a method that includes at least some of the operations performed by the system and/or the electronic device.

Another embodiment provides a computer-program product for use with the system and/or the electronic device. This computer-program product includes instructions for at least some of the operations performed by the system and/or the electronic device.

### BRIEF DESCRIPTION OF THE FIGURES

FIG. 1 is a block diagram illustrating a system that includes electronic devices in accordance with an embodiment of the present disclosure.

FIG. 2 is a flow chart illustrating a method for establishing a common encrypted link between a first electronic device and a second electronic device in accordance with an embodiment of the present disclosure.

FIG. 3 is a flow chart illustrating the method of FIG. 2 in accordance with an embodiment of the present disclosure.

FIG. 4 is a block diagram illustrating an electronic device that performs the method of FIGS. 2 and 3 in accordance with an embodiment of the present disclosure.

FIG. 5 is a block diagram illustrating a data structure for use in the electronic device of FIG. 4 in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

Embodiments of a system, a technique for establishing a common encrypted link between a first electronic device and a second electronic device in physical proximity in the system, and a computer-program product (e.g., software) for use with the system are described. During operation of the system, a user of a first electronic device in the system provides a notification that initiates secure device pairing. In response to the notification, the first electronic device conducts a first key exchange in an audible audio spectrum to the second electronic device in the system using a first zero-knowledge protocol. After the first key is received by the second electronic device, the second electronic device conducts a second key exchange in the audible audio spectrum to the first electronic device using a second zero-knowledge protocol, thereby establishing the common encrypted link between the first electronic device and the second electronic device.

By establishing the common encrypted link, this communication technique facilitates the use of portable electronic devices when conducting financial and/or legal transactions. Consequently, the communication technique may make it easier for users to conduct such transactions, thereby facilitating commercial activity.

In the discussion that follows, a user may include one of a variety of entities, such as: an individual, an organization, a business and/or a government agency. Furthermore, a ‘business’ should be understood to include: for-profit corporations, non-profit corporations, organizations, groups of individuals, sole proprietorships, government agencies, partnerships, etc.

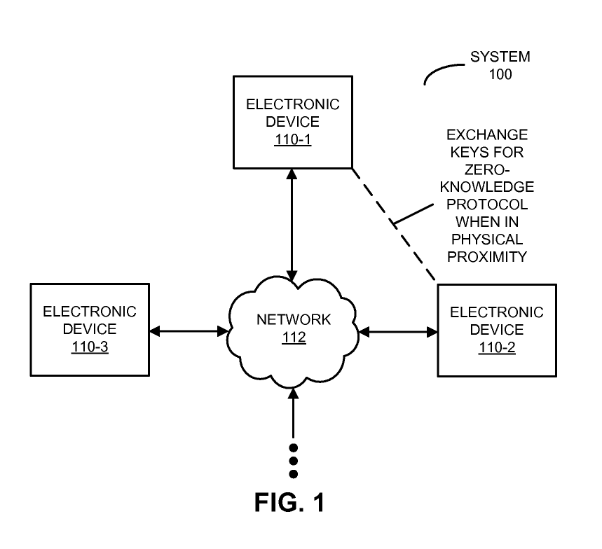

We now describe embodiments of the system. FIG. 1 presents a block diagram illustrating a system 100 that includes electronic devices 110. At least one of electronic devices 110 may be a portable or mobile electronic device. Moreover, electronic devices 110 may include: a computer, a point-of-sale device or terminal, an automatic teller machine, etc.

A user of one of electronic devices 110 (such as electronic device 110-1) may establish a common encrypted link with another one of electronic devices 110 (such as electronic device 110-2). In particular, the user may provide a notification that initiates secure device pairing of electronic devices 110-1 and 110-2. For example, the user may: activate an icon on a display, press a button on electronic device 110-1, shake device 110-1, and/or bring device 110-1 in immediate physical proximity with device 110-2.

In response to the notification, electronic device 110-1 may conduct a first key exchange in an audible audio spectrum (which can be perceived by the user, as well as another user of electronic device 110-2) to electronic device 110-2 using a first zero-knowledge protocol. For example, electronic device 110-1 may generate an audio signal in which the first key is encoded, and may output or transmit the modulated audio signal using a speaker.

After the first key is received by electronic device 110-2 (for example, via a microphone on electronic device 110-2 that receives the transmitted audio signal, which is then decoded to recover the first key), electronic device 110-2 may conduct a second key exchange in the audible audio spectrum (which can also be perceived by the user and the other user) to electronic device 110-2 using a second zero-knowledge protocol (which may be the same as or different than the first zero-knowledge protocol). For example, electronic device 110-2 may generate another audio signal (which may be the same of different than the first audio signal) in which the second key is encoded, and may output or transmit the other audio signal using a speaker.

In this way, the common encrypted link between electronic devices 110-1 and 110-2 may be established. In particular, once the first and second keys have been exchanged, a shared key may be generated based on the first key, the second key, and/or additional private keys on the electronic devices 110-1 and 110-2. This shared key may be used in the common encrypted link. In addition, private keys may be used to encode and/or decode communication via the common encrypted link.

Note that, by leveraging a perceptible channel (in the preceding example, audible sound) to exchange the keys, the users of electronic devices 110-1 and 110-2 can monitor and verify that the common encrypted link has only been established between these electronic devices (i.e., that a ‘man-in-the-middle’ or MITM attack has not occurred). For example, the users can verify that no one else has interfered with the audio signals in the audible audio spectrum used to exchange the keys. If this is not the case, either of the users may be able to cancel or disable the common encrypted link.

Therefore, the communication technique provides a simple (at the minimum, electronic devices 110-1 and 110-2 need to generate, produce, receive and process the exchanged audio signals) and verifiable approach for establishing communication security between electronic devices 110-1 and 110-2. In the process, a trusted off-line certification authority or a trusted third party is not required. This may allow users without a previous direct or indirect trust relationship to conduct a secure transaction via their electronic devices. Moreover, the communication can be wireless, thereby obviating the need for physical security, such as coupling the portable electronic devices with a physical cable (which, while secure, is inconvenient and is often impractical because, in general, a universal cable that can couple two arbitrarily selected electronic devices does not exist).

Furthermore, note that a zero-knowledge protocol can be conducted in the open, and that even if a third party intercepts the communication, they will be unable to use it to implement a MITM attack. For example, in the Diffie-Hellman (D-H) key exchange protocol, each party (i.e., each of the users of electronic devices 110-1 and 110-2) selects a long ‘private’ random number, such as A1 and A2 (which is not communicated or exchanged between electronic devices 110-1 and 110-2). Then, in the D-H key exchange protocol, additional ‘public’ numbers B1 and B2 are generated from A1 and A2, respectively (these are the keys that are exchanged between electronic devices 110-1 and 110-2). These additional numbers have the property or characteristic that they cannot be used to compute A1 or A2 (thus, even if a third party intercepts B1 or B2, they cannot recover A1 or A2 in a computationally efficient manner). Consequently, the D-H key exchange protocol is asymmetric. Note that, when the public numbers are exchanged between electronic devices 110-1 and 110-2, the shared key may be computed on each electronic device using the originally generated private random numbers and the received public numbers according to the D-H key exchange protocol

In some embodiments, the computed shared key is then used to establish one or more additional secure or confidential communication links between electronic devices 110-1 and 110-2 using another communication protocol (such as IEEE 802.11 or WiFi, BlueTooth™, etc.) in network 112. For example, via the common encrypted link, electronic devices 110-1 and 110-2 can exchange BlueTooth™ Media Access Control addresses and/or any additional information required to establish a confidential link over a BlueTooth™ or another communication protocol.

In general, the communication technique is applicable to any face-to-face interactions or transactions that occur when electronic devices 110-1 and 110-2 are in proximity or at point-blank range (for example, a speaker of electronic device 110-1 may be placed next to, such as within an inch, a foot or a meter of, a microphone in electronic device 110-2). Moreover, the communication technique may be implemented by: a provider of one or more of electronic devices 110 (such as a cellular-telephone manufacturer), a developer of firmware that executes on one or more of electronic devices 110, and/or a developer of software that executes in an environment (such as an operating system) of one or more of electronic devices 110.

In an exemplary embodiment, software modems in electronic devices 110-1 and 110-2 are used to encode and decode the keys in the audio signals for communication over an audio channel in the audible spectrum. Furthermore, the communication technique may be used to establish the common encryption link between electronic devices 110-1 and 110-2 in less than 2 s.

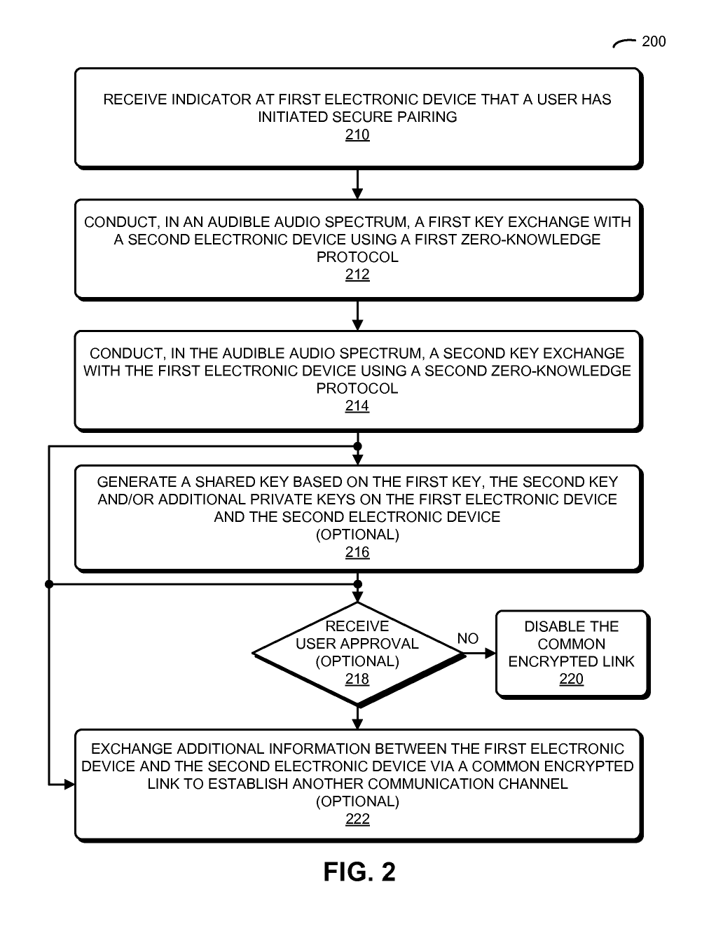

We now describe embodiments of the communication technique. FIG. 2 presents a flow chart illustrating a method 200 for establishing a common encrypted link between a first electronic device and a second electronic device in system 100 (FIG. 1). During operation, a first electronic device in the system receives a notification that a user has initiated secure device pairing (operation 210). In response to the notification, the first electronic device conducts, in an audible audio spectrum, a first key exchange with the second electronic device in the system using a first zero-knowledge protocol (operation 212). After the first key is received by the second electronic device, the second electronic device conducts, in the audible audio spectrum, a second key exchange with the first electronic device using a second zero-knowledge protocol (operation 214), thereby establishing the common encrypted link between the first electronic device and the second electronic device.

In some embodiments, the first electronic device and/or the second electronic device optionally generate a shared key based on the first key and the second key, where the common encrypted link uses the shared key (operation 216). Moreover, the shared key may also be optionally generated by the first electronic device and/or the second electronic device using additional private keys that are generated by the first electronic device and/or the second electronic device (operation 216).

Furthermore, in some embodiments the first electronic device optionally receives user approval of the common encryption link (operation 218). If user approval of the common encrypted link is not received, the first electronic device and/or the second electronic device may disable the common encrypted link between the first electronic device and the second electronic device (operation 220).

Additionally, in some embodiments additional information is optionally exchanged between the first electronic device and the second electronic device via the common encrypted link to establish another communication channel between the first electronic device and the second electronic device (operation 222), such as a BlueTooth™ link.

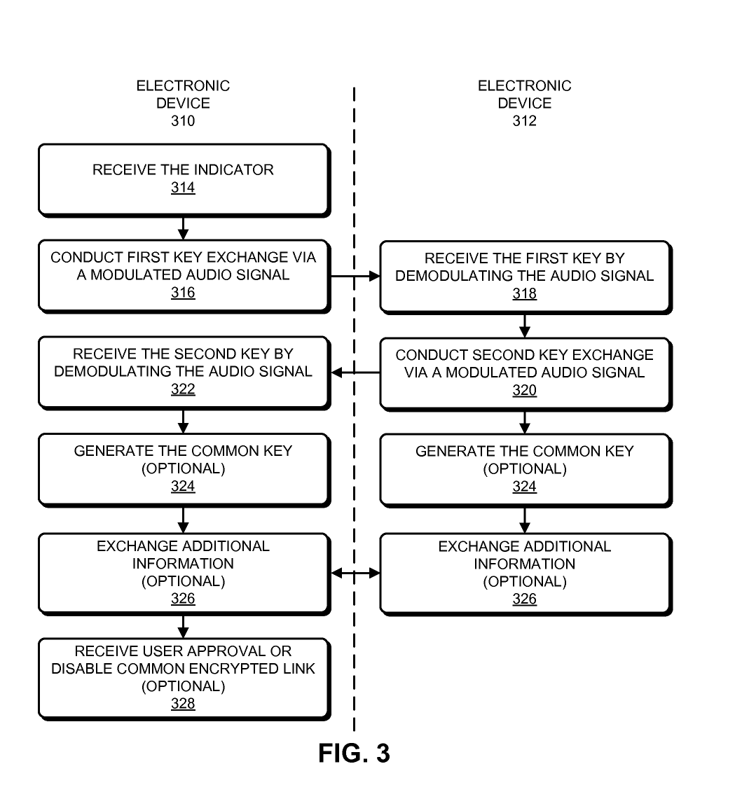

The interaction between the first electronic device and the second electronic device while the common encrypted link is established is illustrated in FIG. 3, which presents a flow chart illustrating method 200 (FIG. 2). During this method, electronic device 310 receives the notification from a user (operation 314). In response to the notification, electronic device 310 conducts, in the audible audio spectrum, the first key exchange with electronic device 312 via an audio signal using the first zero-knowledge protocol (operation 316).

After the first key is received by electronic device 312 by demodulating the audio signal (operation 318), electronic device 312 conducts, in the audible audio spectrum, the second key exchange with electronic device 310 via an audio signal using the second zero-knowledge protocol (operation 320). This second key is received by electronic device 310 by demodulating the audio signal (operation 322).

In some embodiments, electronic device 310 and/or electronic device 312 optionally generate a shared key based on the first key, the second key, and/or additional private keys that are generated by and/or stored on electronic device 310 and/or electronic device 312 (operation 324)

Furthermore, in some embodiments additional information is optionally exchanged between electronic device 310 and electronic device 312 via the common encrypted link to establish another communication channel between electronic device 310 and electronic device 312 (operation 326).

Additionally, in some embodiments electronic device 310 optionally receives user approval of the common encryption link (operation 328). If user approval of the common encrypted link is not received, electronic device 310 and/or electronic device 312 may disable the common encrypted link between electronic device 310 and electronic device 312 (operation 328).

In some embodiments of method 200 (FIGS. 2 and 3) there may be additional or fewer operations. For example, the first key exchange and the second key exchange may be performed multiple times until the common encrypted link is successfully established. This may be useful in noisy environments. Moreover, the order of the operations may be changed, and/or two or more operations may be combined into a single operation.

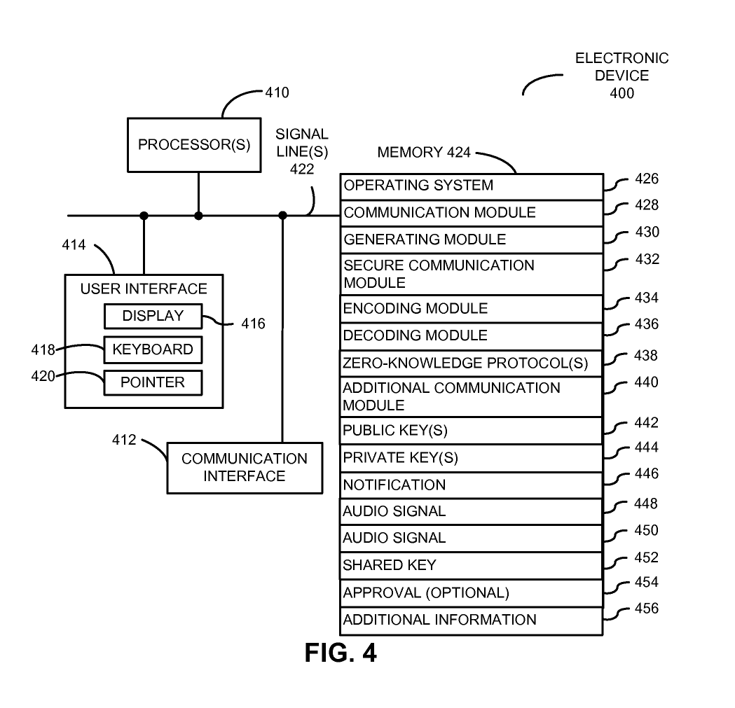

We now describe one of the electronic devices. FIG. 4 presents a block diagram illustrating an electronic device 400 in system 100 (FIG. 1) that performs method 200 (FIGS. 2 and 3). Electronic device 400 includes one or more processing units or processors 410, a communication interface 412, a user interface 414, and one or more signal lines 422 coupling these components together. Note that the one or more processors 410 may support parallel processing and/or multi-threaded operation, the communication interface 412 may have a persistent communication connection, and the one or more signal lines 422 may constitute a communication bus. Moreover, the user interface 414 may include: a display 416, a keyboard 418, and/or a pointer 420, such as a mouse.

Memory 424 in electronic device 400 may include volatile memory and/or non-volatile memory. More specifically, memory 424 may include: ROM, RAM, EPROM, EEPROM, flash memory, one or more smartcards, one or more magnetic disc storage devices, and/or one or more optical storage devices. Memory 424 may store an operating system 426 that includes procedures (or a set of instructions) for handling various basic system services for performing hardware-dependent tasks. Memory 424 may also store procedures (or a set of instructions) in a communication module 428. These communication procedures may be used for communicating with one or more electronic devices, computers and/or servers, including electronic devices, computers and/or servers that are remotely located with respect to electronic device 400.

Memory 424 may also include multiple program modules (or sets of instructions), including: generating module 430 (or a set of instructions), secure communication module 432 (or a set of instructions), encoding module 434 (or a set of instructions), decoding module 436 (or a set of instructions), zero-knowledge protocol(s) 438 (or a set of instructions), and/or additional communication module 440 (or a set of instructions). Note that one or more of these program modules (or sets of instructions) may constitute a computer-program mechanism.

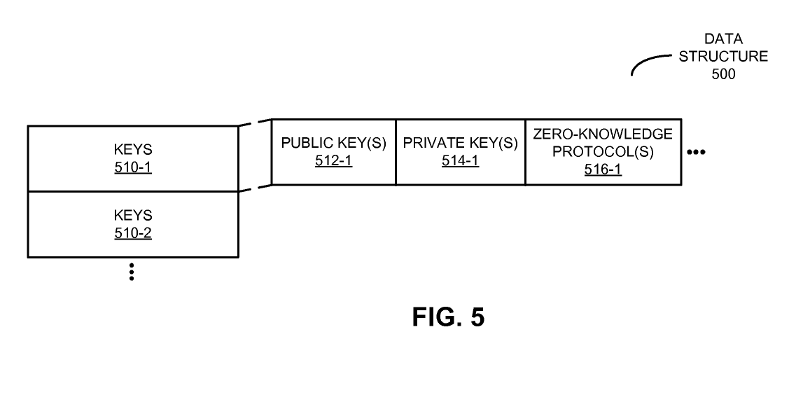

During method 200 (FIGS. 2 and 3), generating module 430 may generate one or more public keys 442 and one or more associated private keys 444 based on the one or more zero-knowledge protocol(s) 438. The results may be stored in a data structure. This data structure is shown in FIG. 5, which presents a block diagram illustrating a data structure 500. In particular, data structure 500 may include keys 510. For example, key 510-1 may include: public key(s) 512-1, private key(s) 514-1, and/or zero-knowledge protocol(s) 516-1.

Referring back to FIG. 4, when a user provides a notification 446 (for example, via user interface 414), encoding module 434 may encode one of public keys 442 in audio signal 448. Next, secure communication module 432 may exchange this audio signal with another electronic device via communication module 428 and communication interface 412.

Subsequently, secure communication module 432 may receive audio signal 450 (which may be different than audio signal 448) via communication module 428 and communication interface 412. Moreover, decoding module 436 may decode audio signal 450 to recover another of public keys 442.

Using the exchanged public keys in public keys 442 and/or the associated private keys in private keys 444, generating module 430 may generate shared key 452 based on the one or more zero-knowledge protocol(s) 438. This shared key may be used by secure communication module 432 to conduct secure communication with the other electronic device via the common encrypted link.

In some embodiments, a user of electronic device 400 may provide optional approval 454 of the common encrypted link to secure communication module 432; otherwise, secure communication module 432 may disable the common encrypted link.

Furthermore, in some embodiments additional information 456 is optionally exchanged between electronic device 400 and the other electronic device via the common encrypted link to establish another communication channel between electronic device 400 and the other electronic device. Subsequently, additional communication module 440 may communicate information between electronic device 400 and the other electronic device using the other communication channel.

Instructions in the various modules in memory 424 may be implemented in: a high-level procedural language, an object-oriented programming language, and/or an assembly or machine language. Note that the programming language may be compiled or interpreted, e.g., configurable or configured, to be executed by the one or more processors 410.

Although electronic device 400 is illustrated as having a number of discrete items, FIG. 4 is intended to be a functional description of the various features that may be present in electronic device 400 rather than a structural schematic of the embodiments described herein. In practice, and as recognized by those of ordinary skill in the art, the functions of electronic device 400 may be distributed over a large number of electronic devices, servers or computers in system 100 (FIG. 1), with various groups of the electronic devices, servers or computers performing particular subsets of the functions. In some embodiments, some or all of the functionality of electronic device 400 may be implemented in one or more application-specific integrated circuits (ASICs) and/or one or more digital signal processors (DSPs).

Electronic devices 110 in system 100 (FIG. 1) and/or electronic device 400 may include one of a variety of devices capable of manipulating computer-readable data or communicating such data between two or more computing systems over a network, including: a personal computer, a laptop computer, a mainframe computer, a point-of-sale device, an automated teller machine, a portable electronic device (such as a cellular phone or PDA), a server and/or a client computer (in a client-server architecture). Moreover, network 112 (FIG. 1) may include: the Internet, World Wide Web (WWW), an intranet, LAN, WAN, MAN, a cellular-telephone network, or a combination of networks, or other technology enabling communication between electronic devices or computing systems.

System 100 (FIG. 1), electronic device 400 (FIG. 4) and/or data structure 500 may include fewer components or additional components. Moreover, two or more components may be combined into a single component, and/or a position of one or more components may be changed. In some embodiments, the functionality of system 100 (FIG. 1) and/or electronic device 400 may be implemented more in hardware and less in software, or less in hardware and more in software, as is known in the art.

While the preceding discussion illustrated the use of the communication technique to establish a common encrypted link between two electronic devices via the exchange of keys in the audible audio spectrum using one or more zero-knowledge protocols, this approach may be used in a variety of applications, including those that use a different range(s) of frequencies and/or alternative encryption protocols. (In general, a variety of physical phenomena that can be perceived by the users while a common encrypted link is being established may be used in addition to or in place of the audible audio signals.) Furthermore, in other embodiments the communication technique is used to establish a common encrypted link between groups of more than two electronic devices.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. A method for establishing a common encrypted link between a first electronic device and a second electronic device, comprising:
receiving a notification that a user has initiated secure device pairing on the first electronic device;
in response to the notification, conducting, in an audible audio spectrum, a first key exchange from the first electronic device to the second electronic device using a first zero-knowledge protocol; and
after the first key is received by the second electronic device, conducting, in the audible audio spectrum, a second key exchange from the second electronic device to the first electronic device using a second zero-knowledge protocol, thereby establishing the common encrypted link between the first electronic device and the second electronic device.

2. The method of claim 1, wherein the first zero-knowledge protocol is different than the second zero-knowledge protocol.

3. The method of claim 1, wherein the common encrypted link uses the first key and the second key.

4. The method of claim 1, wherein the method further comprises generating a shared key based on the first key, the second key, and additional private keys on the first electronic device and the second electronic device; and
wherein the common encrypted link uses the shared key.

5. The method of claim 1, wherein the first electronic device and the second electronic device are physically proximate to each other.

6. The method of claim 5, wherein a distance between the first electronic device and the second electronic device is less than a predefined distance.

7. The method of claim 1, wherein the method further comprises exchanging additional information between the first electronic device and the second electronic device via the common encrypted link to establish another communication channel between the first electronic device and the second electronic device.

8. The method of claim 1, wherein the first key exchange and the second key exchange are performed multiple times until the common encrypted link is successfully established.

9. The method of claim 1, wherein the method further comprises receiving user approval of the common encryption link on the first electronic device.

10. The method of claim 9, wherein, if user approval of the common encrypted link is not received, the method further comprises disabling the common encrypted link between the first electronic device and the second electronic device.

11. The method of claim 1, wherein, during the first key exchange, the first key is encoded in a first audio signal; and
wherein, during the second key exchange, the second key is encoded in a second audio signal.

12. The method of claim 11, wherein the first audio signal is different than the second audio signal.

13. A non-transitory computer-program product for use in conjunction with a system, the computer-program product comprising a computer-readable storage medium and a computer-program mechanism embedded therein, to facilitate establishment of a common encrypted link between a first electronic device and a second electronic device, the computer-program mechanism including:
instructions for receiving a notification that a user has initiated secure device pairing on the first electronic device;
in response to the notification, instructions for conducting, in an audible audio spectrum, a first key exchange from the first electronic device to the second electronic device using a first zero-knowledge protocol; and
after the first key is received by the second electronic device, instructions for conducting, in the audible audio spectrum, a second key exchange from the second electronic device to the first electronic device using a second zero-knowledge protocol, thereby establishing the common encrypted link between the first electronic device and the second electronic device.

14. The computer-program product of claim 13, wherein the first zero-knowledge protocol is different than the second zero-knowledge protocol.

15. The computer-program product of claim 13, wherein the common encrypted link uses the first key and the second key.

16. The computer-program product of claim 13, wherein the computer-program mechanism further includes instructions for generating a shared key based on the first key, the second key, and additional private keys on the first electronic device and the second electronic device; and
wherein the common encrypted link uses the shared key.

17. The computer-program product of claim 13, wherein the computer-program mechanism further includes instructions for exchanging additional information between the first electronic device and the second electronic device via the common encrypted link to establish another communication channel between the first electronic device and the second electronic device.

18. The computer-program product of claim 13, wherein the first key exchange and the second key exchange are performed multiple times until the common encrypted link is successfully established.

19. The computer-program product of claim 13, wherein the computer-program mechanism further includes instructions for receiving user approval of the common encryption link on the first electronic device.

20. The computer-program product of claim 19, wherein, if user approval of the common encrypted link is not received, the computer-program mechanism further includes instructions for disabling the common encrypted link between the first electronic device and the second electronic device.

21. The computer-program product of claim 13, wherein, during the first key exchange, the first key is encoded in a first audio signal; and
wherein, during the second key exchange, the second key is encoded in a second audio signal.

22. A system, comprising:
a processor;
memory; and
a program module, wherein the program module is stored in the memory and configurable to be executed by the processor to facilitate establishment of a common encrypted link between a first electronic device and a second electronic device, the program module including:
instructions for receiving a notification that a user has initiated secure device pairing on the first electronic device;
in response to the notification, instructions for conducting, in an audible audio spectrum, a first key exchange from the first electronic device to the second electronic device using a first zero-knowledge protocol; and
after the first key is received by the second electronic device, instructions for conducting, in the audible audio spectrum, a second key exchange from the second electronic device to the first electronic device using a second zero-knowledge protocol, thereby establishing the common encrypted link between the first electronic device and the second electronic device.

23. An electronic device, comprising:
a processor;
memory; and
a program module, wherein the program module is stored in the memory and configurable to be executed by the processor to facilitate establishment of a common encrypted link between the electronic device and a second electronic device, the program module including:
instructions for receiving a notification that a user has initiated secure device pairing on the electronic device;
in response to the notification, instructions for conducting, in an audible audio spectrum, a first key exchange from the electronic device to the second electronic device using a first zero-knowledge protocol; and
instructions for conducting, in the audible audio spectrum, a second key exchange from the second electronic device to the electronic device using a second zero-knowledge protocol, thereby establishing the common encrypted link between the electronic device and the second electronic device.
